(19) United States
(12) Patent Application Publication
(10) Pub. No.: US 2015/0329096 A1
(43) Pub. Date: Nov. 19, 2015

(54) METHODS AND KITS FOR TESTING BRAKE FLUID

(71) Applicant: Ronald Schornstein, Mountain Lakes, NJ (US)

(72) Inventor: Ronald Schornstein, Mountain Lakes, NJ (US)

(21) Appl. No.: 14/711,927

(22) Filed: May 14, 2015

Related U.S. Application Data
(60) Provisional application No. 61/993,440, filed on May 15, 2014.

(51) Int. Cl. B60T 17/22; G01N 31/22

(52) U.S. Cl. CPC B60T 17/221; G01N 31/221

(57) ABSTRACT

The present invention provides methods and kits for assessing whether brake fluid in a vehicle should be replaced, evaluating the degradation of brake fluid, and assessing the virtual age of brake fluid. The methods feature obtaining a sample of brake fluid from a vehicle; measuring the pH of the brake fluid; and assessing whether the brake fluid in the vehicle should be replaced, evaluating the degradation of brake fluid, or assessing the virtual age of brake fluid. The brake fluid is determined to be in need of replacement or degraded beyond safe levels if the pH of the brake fluid is less than about 6.5, 6.25, 6.0, 5.9, 5.8, 5.75, 5.7, 5.6, or 5.5.

### FIELD OF THE INVENTION

This invention is related to methods and devices for testing the condition of automotive brake fluid. In particular, the invention provides novel and useful methods and kits based upon a correlation between brake fluid condition and pH.

### BACKGROUND OF THE INVENTION

Brake fluid is used to transmit the pressure exerted on a motor vehicle's brake pedal to the cylinders of the braking system. Commonly used brake fluids consist of glycol-based liquids categorized as DOT3 and DOT4 on the basis of their boiling point. In order to prevent boiling of the brake fluid due to overheating during use, DOT3 and DOT4 fluids are required to have a dry boiling point (absent moisture in fluid) of at least 401° F. (205° C.) and 446° F. (230° C.) respectively, to insure proper brake operation at all temperature conditions. A low boiling point may cause brake fluid to vaporize under high temperature operating conditions, for example, during constant braking downhill. Vaporization may in turn create pockets of compressible vapor in the system that may compromise the effectiveness of the braking system. This may in some instances lead to complete brake failure.

Glycol-based brake fluids are hygroscopic, and they readily absorb moisture thereby leading to a reduced boiling point, a dangerous result. Therefore, DOT3 and DOT4 brake fluids should be replaced after they have absorbed enough moisture so that their vaporization temperatures are reduced to about 284° F. (140° C.) and 311° F. (155° C.), respectively. These are the minimum acceptable wet boiling points (i.e., the boiling points with moisture absorbed by the brake fluid) considered safe for brake operation. These standards are currently set by the U.S. Department of Transportation. The moisture content of brake fluid increases with age and exposure to humidity. Therefore, brake fluid should be checked periodically, and the brake fluid should be replaced when its boiling point nears these safety thresholds. The moisture content of brake fluid may be tested using standard laboratory procedures and instruments or a moisture test strip.

Petty, U.S. Pat. No. 6,691,562 teach methods and kits useful for estimating the boiling point of brake fluid based upon a correlation between moisture content and copper content in the fluid. Petty teaches methods of establishing service requirements for a brake fluid in a vehicle's brake system as a function of a variable indicative of the fluid's service age and service mileage, by (a) determining a correlation between the variable and a content of copper, iron, and zinc in the fluid; (b) measuring a current value of the copper, iron, and zinc in the fluid by reaction with a test reactant exposed to the brake fluid: (c) determining a current approximation of the variable on the basis of the copper, iron, and zinc content; and (d) carrying out a maintenance schedule for the brake system on the basis of the current approximation of the variable indicative of the fluid's service age and service mileage.

Petty further teaches kits for establishing service requirements for a brake fluid in a vehicle's brake system as a function of a variable indicative of the fluid's service age and service mileage having a test standard including a color chart representing a correlation between the variable and copper, iron, and zinc content in the brake fluid; a test reactant capable of reacting with the copper, iron, and zinc in the brake fluid and producing an indication of a current copper, iron, and zinc content in the brake fluid upon exposure of a test reactant with the brake fluid; and a predetermined empirical maintenance schedule for the brake system based on the variable indicative of the fluid's service age and service mileage. Petty also teaches a brake fluid dispenser and test kit for replacing brake fluid in a vehicle's brake system as a function of a variable indicative of the fluid's service age and service mileage having a container with brake fluid, a test standard including a color chart representing a correlation between the variable and a copper, iron, and zinc content in the brake fluid, a test reactant capable of reacting with the copper, iron, and zinc in the brake fluid and producing an indication of a current copper, iron, and zinc content in the brake fluid upon exposure of the test reactant with the wake fluid, and a predetermined empirical maintenance schedule for the brake system the variable indicative of the fluid's service age and service mileage.

Some constituents of brake systems are corrosive. Contamination of brake fluid with such corrosive constituents may progressively damage metallic tubing and other parts of the brake system. Amines may be added to some brake fluids to inhibit corrosion and prevent damage to metal parts that operate in contact with the brake fluid. As brake fluid ages, its anticorrosive properties may be measured in terms of reserve alkalinity. That is, the amount of amines remaining present in the brake fluid to buffer acidity resulting from the breakdown of some constituents of the brake fluid may be used as a measure of the brake fluid anticorrosive properties. The amine content is reduced over time due to thermal oxidation and volatization. This reduction in amine content then decreases the anticorrosive properties. The pH of new or substantially unused brake fluid should normally be in the range of 7 to 11.

The reserve alkalinity of DOT3 and DOT4 brake fluids may be reduced to about 20 percent of the original value after 18 to 20 months of normal operation. The moisture content of typical brake fluids increases about 1% per year of service, absent additional maintenance. In view of the foregoing, it is apparent that brake fluids must be checked and periodically replaced to prevent corrosion and potential braking failure in the brake system.

This methods and kits described herein provide a further advance in the art based on the recognition that the pH of brake fluid is a excellent predictor of the condition of the fluid.

### SUMMARY OF THE INVENTION

The presently described methods and kits are useful for determining whether the brake fluid in a vehicle has deteriorated to such a degree that it should be replaced based upon measuring the pH of the brake fluid. Hence, the presently described methods and kits facilitate or enable making a maintenance decision largely independent of prior time and mileage estimates.

An objective of the invention is to provide methods and kits for assessing the remaining anti-corrosive properties of brake fluid using a test similar to those used to determine boiling point, e.g. aperture moisture test strip. Another objective is to provide methods that can be rapidly performed and kits that may be rapidly used during regular automotive maintenance.

Still another objective is to provide methods and kits that are economical and are user friendly. Yet another objective is to provide methods and kits that do not require obtaining a sample of brake fluid from the braking system but rather may be performed and used by taking a sample from the master cylinder thereby facilitating ease of use.

In a first aspect, the present invention provides methods for assessing whether brake fluid in a vehicle should be replaced. The methods feature

(a) Obtaining a sample of brake fluid from a vehicle;

(b) Measuring the pH of the brake fluid; and

(c) Assessing whether the brake fluid in the vehicle should be replaced.

The methods may further feature comparing the pH of the brake fluid to a reference value or standard. The assessing whether brake fluid in a vehicle should be replaced may include determining whether the pH of the brake fluid is less than about 6.5, 6.25, 6.0, 5.9, 5.8, 5.75, 5.7, 5.6, 5.5, 5.4, 5.3, or 5.25. In some embodiments, the brake fluid is determined to be in need of replacement if the pH of the brake fluid is less than about 6.0, 5.9, 5.8, 5.75, 5.7, 5.6, or 5.5. The methods may further feature measuring the concentration of one or more metal such as, for instance, copper, iron, or zinc. The methods may also further feature visually inspecting the color or texture of the brake fluid. Also, the methods may further feature assessing or measuring the moisture content of the brake fluid.

In some instances, the measuring the pH of the brake fluid is performed using a reactive test strip adapted to measure the pH of brake fluid in terms of a readily visible color change. The strip may be immersed in the brake fluid, and the resulting color acquired by reaction with the brake fluid may be compared to a pH color chart or to a color standard. If the color change indicates a lower-than-acceptable pH level, for instance, less than about 6.5, 6.25, 6.0, 5.9, 5.8, 5.75, 5.7, 5.6, 5.5, 5.4, 5.3, 5.2, 5.1 or 5.0, the brake fluid may be considered degraded, or unable to provide adequate protection, or corrosive and assessed as in need of replacement for proper maintenance of the vehicle's braking system. Measuring the pH of the brake fluid may be performed in an automated manner using an optical instrument to compare the color obtained from the pH test to a predetermined standard.

In a second aspect, the present invention provides methods for evaluating the degradation of brake fluid. The methods feature

(a) Obtaining a sample of brake fluid from a vehicle;

(b) Measuring the pH of the brake fluid; and

(c) Assessing the degradation of the brake fluid.

The methods may further feature comparing the pH of the brake fluid to a reference value or standard. The assessing the degradation of the brake fluid may include determining whether the pH of the brake fluid is less than about 6.5, 6.25, 6.0, 5.9, 5.8, 5.75, 5.7, 5.6, 5.5, 5.4, 5.3, or 5.25. In some embodiments, the brake fluid is determined to be degraded to the degree that it may be in need of replacement if the pH of the brake fluid is less than about 6.0, 5.9, 5.8, 5.75, 5.7, 5.6, or 5.5. The methods may further feature measuring the concentration of one or more metal such as, for instance, copper, iron, or zinc. The methods may also further feature visually inspecting the color or texture of the brake fluid. Also, the methods may further feature assessing or measuring the moisture content of the brake fluid.

In some instances, the measuring the pH of the brake fluid is performed using a reactive test strip adapted to measure the pH of brake fluid in terms of a readily visible color change. The strip may be immersed in the brake fluid, and the resulting color acquired by reaction with the brake fluid may be compared to a pH color chart or to a color standard. If the color change indicates a lower-than-acceptable pH level, for instance, less than about 6.5, 6.25, 6.0, 5.9, 5.8, 5.75, 5.7, 5.6, 5.5, 5.4, 5.3, 5.2, 5.1 or 5.0, the brake fluid may be considered degraded, or unable to provide adequate protection, or corrosive and may be assessed as in need of replacement for proper maintenance of the vehicle's braking system. The measuring the pH of the brake fluid may be performed in an automated manner using an optical instrument to compare the color obtained from the pH test to a predetermined standard.

In a third aspect, the present invention provides methods for assessing the virtual age of brake fluid. The methods feature

(a) Obtaining a sample of brake fluid from a vehicle;

(b) Measuring the pH of the brake fluid; and

(c) Assessing the virtual age of brake fluid.

The methods may further feature comparing the pH of the brake fluid to a reference value or standard. The virtual age of the brake fluid may refer to the wear and tear on the brake fluid resulting from actual mileage or age. The assessing the virtual age of brake fluid may include determining whether the pH of the brake fluid is less than about 6.5, 6.25, 6.0, 5.9, 5.8, 5.75, 5.7, 5.6, 5.5, 5.4, 5.3, or 5.25. In some embodiments, the brake fluid is determined to be in need of replacement if the pH of the brake fluid is less than about 6.0, 5.9, 5.8, 5.75, 5.7, 5.6, or 5.5. The methods may further feature measuring the concentration of one or more metal such as, for instance, copper, iron, or zinc. The methods may also further feature visually inspecting the color or texture of the brake fluid. Also, the methods may further feature assessing or measuring the moisture content of the brake fluid.

In some instances, the measuring the pH of the brake fluid is performed using a reactive test strip adapted to measure the pH of brake fluid in terms of a readily visible color change. The strip may be immersed in the brake fluid, and the resulting color acquired by reaction with the brake fluid may be compared to a pH color chart or to a color standard. If the color change indicates a lower-than-acceptable pH level, for instance, less than about 6.5, 6.25, 6.0, 5.9, 5.8, 5.75, 5.7, 5.6, 5.5, 5.4, 5.3, 5.2, 5.1 or 5.0, the brake fluid may be considered degraded, or unable to provide adequate protection, or corrosive and may be assessed as in need of replacement for proper maintenance of the vehicle's braking system. The measuring the pH of the brake fluid may be performed in an automated manner using an optical instrument to compare the color obtained from the pH test to a predetermined standard.

In a fourth aspect, the present invention provides a kit useful for assessing whether brake fluid in a vehicle should be replaced or useful for evaluating the degradation of brake fluid or useful for assessing the virtual age of brake fluid. The kit contains a means for measuring the pH of the brake fluid such as for instance, a test strip or an automated instrument or device for measuring the pH. The kit may also contain a color chart for correlating the color of a test strip to an actual pH or an automated device for correlating the color of a test strip to an actual pH. The kit may optionally contain a means for obtaining a sample of brake fluid from a vehicle such as, for instance, a pipette, and one or more of a test tube, a container, or a vial. The kit may also contain instructions useful for assessing whether brake fluid in a vehicle should be replaced or useful for evaluating the degradation of brake fluid or useful for assessing the virtual age of brake fluid. The instructions may determine that the brake fluid in a vehicle should be replaced, or may evaluate the degradation of the brake fluid is such that it is no longer safe, or may assess the virtual age of the brake fluid is such that it is no longer safe to use if the pH of the brake fluid is less than about 6.5, 6.25, 6.0, 5.9, 5.8, 5.75, 5.7, 5.6, 5.5, 5.4, 5.3, 5.2, 5.1 or 5.0. In some particular embodiments, the instructions may determine that the brake fluid in a vehicle should be replaced, or may evaluate the degradation of the brake fluid is such that it is no longer safe, or may assess the virtual age of the brake fluid is such that it is no longer safe to use if the pH of the brake fluid is less than about 6.0, 5.9, 5.8, 5.75, 5.7, 5.6, or 5.5.

### BRIEF DESCRIPTION OF THE DRAWINGS

FIG. 1 represents the results obtained from measuring the pH of brake fluid using a reactive test strip adapted to measure the pH of brake fluid in terms of a readily visible color change. The strips were immersed in the brake fluid, and the resulting color acquired by reaction with the brake fluid was compared to a pH color chart or to a color standard. If the color change indicates a lower-than-acceptable pH level, the brake fluid was considered degraded, or unable to provide adequate protection, or corrosive and assessed as in need of replacement for proper maintenance of the vehicle's braking system.

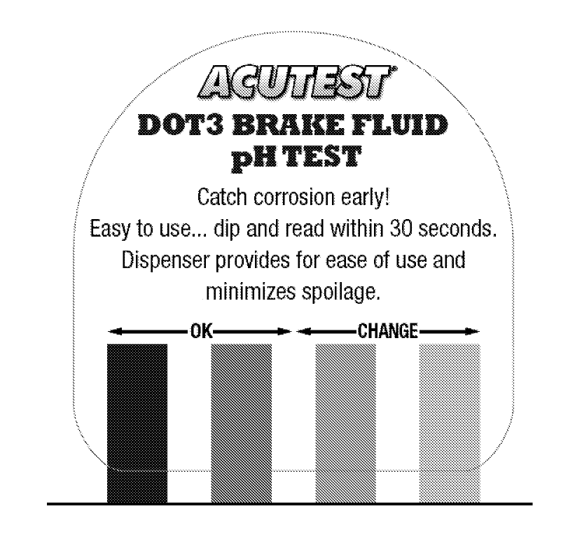

### DETAILED DESCRIPTION OF THE PREFERRED EMBODIMENTS

The methods and kits described herein provide a correlation between the pH of brake fluid and its service age or mileage. The methods and kits described herein also provide a correlation between the pH of brake fluid and degradation of the brake fluid. The pH may be measured using, and the kits may provide a reactive test strip adapted to measure the pH of brake fluid in terms of a readily visible color change. Suitable test strips include the ACUTEST® available from Acustrip, Mountain Lakes, N.J. The test strip may be immersed in the fluid, and the resulting color acquired by reaction with the brake fluid may be compared to a pH color chart or to a color standard representative of the pH. If the color change indicates a lower-than-acceptable pH level, for example, less than about 6.5, 6.25, 6.0, 5.9, 5.8, 5.75, 5.7, 5.6, 5.5, 5.4, 5.3, 5.25, or so the brake fluid may be considered sufficiently degraded so that it is unable to provide adequate protection and also corrosive and in need of replacement for proper maintenance of the vehicle's braking system. In some instances, the pH may be determined in an automated manner using an optical instrument to compare the color obtained from the test strip to a predetermined standard and thereby determine whether a brake fluid change is recommended. Suitable automated instruments include, for instance, an Acustrip 5610 pH pen available from Acustrip, Mountain Lakes, N.J. or one of several pH testers and portable meters available from Jenco Instruments, Inc., San Diego, Calif. The pH testing may be performed in conjunction with, concurrent with or serially with measuring the moisture content of the brake fluid. The moisture content of the brake fluid may be measured using, for instance, a Reichert Optical Brake-Chek® from Reichert Technologies, Depew, N.Y., a suitable device from Misco, Cleveland, Ohio or a Neiko Tools Brake Fluid Tester, commercially available.

It has been shown that low pH brake fluid better predicts the condition of the fluid than moisture or copper (Cu) concentration, with lab results showing false passes indicated by low Cu and moisture values, which the low pH condition predictably cause the fluid to fail corrosion tests. This simple reading can be advantageously used to evaluate brake fluid, even while a vehicle is in the service bay. The methods and kits described herein avoid the tracking of milestones for maintenance purposes with regard to actual service time and/or mileage. Instead, pH may be adopted as a reliable indicator of a vehicle's virtual age, a term used in place of the wear and tear on brake fluid resulting from actual mileage and/or time of service.

### EXAMPLE 1

### Materials and Methods.

ABIC Testing Laboratories, Inc., Fairfield, N.J. was authorized to perform the following corrosion test. The test procedure is the method outlined in the Federal Motor Vehicle Safety Standard (FMVSS) 116, paragraph 55.1.6.

The metal test strips did not show weight changes exceeding 0.2; 0.1; and 0.4; for steel, tinned iron, cast iron; aluminum; and brass or copper, respectively, as measured in weight change, mg/sq. cm. of surface. (b) The metal test strips did not show pitting or etching to an extent discernible without magnification. (c) The water-wet brake fluid at the end of the test showed no jelling at 23±5° C. (73.4±9° F.). (d) No crystalline deposit was formed and adhered to either the glass jar walls or the surface of the metal strips. (e) At the end of the test, sedimentation of the water-wet brake fluid did not exceed 0.10 percent by volume. (f) The pH value of water-wet brake fluid, except DOT 5 SBBF, at the end of the test was not less than 7.0 nor more than 11.5. (g) The cups at the end of the test showed no disintegration, as evidenced by blisters or sloughing. (h) The hardness of the cup did not decrease by more than 15 International Rubber Hardness Degrees (IRHD). (i) The base diameter of the cups did not increase by more than 1.4 mm. (0.055 inch).

Six specified metal corrosion test strips were polished, cleaned, and weighed, then assembled as described. The assembly was placed on a standard wheel cylinder cup in a corrosion test jar, immersed in the water-wet brake fluid, capped and placed in an oven at 100° C. (212° F.) for 120 hours. Upon removal and cooling, the strips, fluid, and cups were examined and tested.

The following equipment was used.

(a) Balance. An analytical balance having a minimum capacity of 50 grams and capable of weighing to the nearest 0.1 mg.

(b) Desiccators. Desiccators containing silica gel or other suitable desiccant.

(c) Oven. Gravity convection oven capable of maintaining the desired set point within 2° C. (3.6° F.).

(d) Micrometer. A machinist's micrometer 25 to 50 mm. (1 to 2 inches) capacity, or an optical comparator, capable of measuring the diameter of the SBR wheel cylinder (WC) cups to the nearest 0.02 mm. (0.001 inch).

### Materials.

(a) Corrosion test strips. Two sets of strips from each of the metals listed in Appendix C of SAE Standard J1703b (1970) (incorporated by reference, See §571.5). Each strip was approximately 8 cm. long, 1.3 cm. wide, not more than 0.6 cm. thick, and had a surface area of 25±5 sq. cm. and a hole 4 to 5 mm. (0.16 to 0.20 inch) in diameter on the centerline about 6 mm. from one end. The hole was clean and free from burrs.

(b) SBR cups. Two unused standard SAE SBR wheel cylinder (WC) cups were used.

(c) Corrosion test jars and lids. Two screw-top straight-sided round glass jars, each having a capacity of approximately 475 ml and inner dimensions of approximately 100 mm in height and 75 mm in diameter, and a tinned steel lid (no insert or organic coating) vented with a hole 0.8±0.1 mm. (0.031±0.004 inch) in diameter (No. 68 drill).

(d) Machine screws and nuts. Clean, rust and oil-free, uncoated mild steel round or fillister head machine screws, size 6 or 8-32 UNC-Class 2A, five-eighths or three-fourths inch long (or equivalent metric sizes), and matching uncoated nuts.

(e) Supplies for polishing strips. Waterproof silicon carbide paper, grit No. 320A and grit 1200; lint-free polishing cloth.

(f) Distilled water

(g) Ethanol

(h) Isopropanol

### Preparation.

(a) Corrosion test strips. Except for the tinned iron strips, abrade corrosion test strips on all surface areas with 320A silicon carbide paper wet with ethanol (isopropanol when testing DOT 5 SBBF fluids) until all surface scratches, cuts and pits visible to an observer having corrected visual acuity of 20/40 (Snellen ratio) at a distance of 300 mm (11.8 inches) were removed. A new piece of paper was used for each different type of metal. Except for the tinned iron strips, the test strips were further abraded on all surface areas with 1200 silicon carbide paper wet with ethanol (isopropanol when testing DOT 5 SBBF fluids), again using a new piece of paper for each different type of metal. The strips were handled with forceps after polishing. The weight of each strip was determined to the nearest 0.1 mg. The strips were assembled on a clean dry machine screw, with matching plain nut, in the order of tinned iron, steel, aluminum, cast iron, brass, and copper. The strips were bent, other than the cast iron, so that there was a separation of 3±0.50 mm. (⅛± 1/64 inch) between adjacent strips for a distance of about 5 cm. (2 inches) from the free end of the strips. The screw was tightened on each test strip assembly so that the strips were in electrolytic contact, and could be lifted by either of the outer strips (tinned iron or copper) without any of the strips moving relative to the others when held horizontally. The strip assemblies were immersed in 90 percent ethyl alcohol. They were then dried with dried filtered compressed air, then desiccated at least 1 hour before use.

(b) SBR WC cups. The base diameters of the two standard SBR cups were measured using an optical comparator or micrometer, to the nearest 0.02 mm. (0.001 inch) along the centerline of the SAE and rubber-type identifications and at right angles to this centerline. The measurements were taken at least 0.4 mm. (0.015 inch) above the bottom edge and parallel to the base of the cup. Any cup was discarded if the two measured diameters differed by more than 0.08 mm. (0.003 inch). The two readings on each cup were averaged. The hardness of the cups were determined according the procedures described. The cups were rinsed in ethanol (isopropanol when testing DOT 5 SBBF fluids) for not more than 30 seconds and wiped dry with a clean lint-free cloth. One cup was placed with lip edge facing up, in each jar. A metal strip assembly was inserted inside each cup with the fastened end down and the free end extending upward. When testing brake fluids, except DOT 5 SBBF, 760 ml of brake fluid was mixed with 40 ml of distilled water. When testing DOT 5 SBBF's, 800 ml of brake fluid was humidified in accordance with procedures described, eliminating determination of the ERBP. Using this water-wet mixture, each strip assembly was covered to a minimum depth of 10 mm above the tops of the strips. The lids were tightened and the jars were placed for 120±2 hours in an oven maintained at 100°±2° C. (212°±3.6° F.). The jars were allowed to cool at 23°±5° C. (73.4°±9° F.) for 60 to 90 minutes. The strips were immediately removed from the jars using forceps, agitating the strip assembly in the fluid to remove loose adhering sediment. The test strips and jars were examined for adhering crystalline deposits.

The metal strips were disassembled, and adhering fluid was removed by flushing with water. Each strip was cleaned by wiping with a clean cloth wetted with ethanol (isopropanol when testing DOT 5 fluids). The strips were examined for evidence of corrosion and pitting. Staining or discoloration were disregarded. The strips were placed in a desiccator containing silica gel or other suitable desiccant, maintained at 23°±5° C. (73.4°±9° F.), for at least 1 hour. Each strip was weighed to the nearest 0.1 mg. The change in weight of each metal strip was determined. The results for the two strips of each type of metal were averaged. Immediately following the cooling period, the cups were removed from the jars with forceps. Loose adhering sediment was removed by agitation of the cups in the mixture. The cups were rinsed in ethanol (isopropanol when testing DOT 5 fluids) and air-dried. The cups were examined for evidence of sloughing, blisters, and other forms of disintegration. The base diameter and hardness of each cup were measured within 15 minutes after removal from the mixture. The mixture was examined for gelling. The mixture was agitated to suspend and uniformly disperse sediment. From each jar, a 100 ml portion of the mixture was transferred to an ASTM cone-shaped centrifuge tube. The percent sediment after centrifuging was determined as described. The pH value of the corrosion text fluid was measured as described. The pH value of the test mixture was measured as described.

### Calculation.

The area of each type of test strip was measured to the nearest square centimeter. The average change in mass for each type was divided by the area of that type.
Corrosion Test with 3% water (typical test uses 5% water). The following properties were determined:
   1. Metals weight change
   2. Final water content
   3. pH after test
   4. Copper level (ppm)
Corrosion Test with 3% water (typical test uses 5% water) and pH adjusted to 5.5 at the start of the test. The following properties were determined:
   1. Metals weight change
   2. Final water content
   3. pH after test
   4. Copper level (ppm)
Standard Corrosion Test with pH adjusted to 6.0 initially.
   1. Metals weight change
   2. pH after test
   3. Copper level (ppm)

### Results.

The results obtained are provided in Tables 1 and 2.

TABLE 1
Brake Fluid Corrosion Test-3% Water

| | | | | Area | Wt Change | Av. Wt Change | Requirement |
|---|---|---|---|---|---|---|---|
| Metal | Initial Wt | Final Wt | Wt Change | sq. cm. | mg/sq.cm. | mg./sq.cm. | mg./sq.cm. |
| Tinned Iron | | | | | | | |
| 1 | 1.9124 | 1.9117 | 0.0007 | 21.5 | 0.03 | 0.02 | <.2 |
| 2 | 1.9612 | 1.9613 | 0.0001 | 21.5 | 0.00 | | |
| Stool | | | | | | | |
| 1 | 18.2072 | 19.2061 | 0.0011 | 25.1 | 0.04 | 0.01 | <.2 |
| 2 | 22.4734 | 22.4742 | −0.0008 | 25.1 | −0.03 | | |
| Aluminum | | | | | | | |
| 1 | 3.4147 | 3.4149 | −0.0002 | 24.7 | −0.01 | −0.01 | <.1 |
| 2 | 3.1149 | 3.1151 | −0.0002 | 24.7 | −0.01 | | |
| Cast Iron | | | | | | | |
| 1 | 28.7277 | 26.7288 | −0.0009 | 26.3 | −0.03 | −0.06 | <.2 |
| 2 | 28.7007 | 26.7028 | −0.0021 | 26.3 | −0.06 | | |
| Brass | | | | | | | |
| 1 | 21.4495 | 21.4491 | 0.0004 | 24.8 | 0.02 | 0.00 | <4 |
| 2 | 22.561 | 22.5615 | −0.0005 | 24.8 | −0.02 | | |
| Copper | | | | | | | |
| 1 | 23.9883 | 23.9848 | 0.0037 | 24.9 | 0.15 | 0.15 | <4 |
| 2 | 23.6053 | 23.6017 | 0.0036 | 24.9 | 0.14 | | |

pH After Test: 9.25
Copper Level: 6 ppm

TABLE 2
Exhibit II
Brake Fluid Corrosion Test-pH Adjusted to 5.5 Initially

| | | | | Area | Wt Change | Av. Wt Change | Requirement | Metal | |
|---|---|---|---|---|---|---|---|---|---|
| Metal | Initial Wt | Final Wt | Wt Change | sq. cm. | mg/sq.cm. | mg./sq.cm. | mg/sq.cm. | Appearance | Comments |
| Tinned Iron | | | | | | | | | |
| 1 | 1.9950 | 1.9548 | 0.0002 | 21.5 | 0.01 | 0.00 | <.2 | Pitted | Failed |
| 2 | 1.9363 | 1.9363 | 0.0000 | 21.5 | 0.00 | | | Pitted | Failed |
| Stool | | | | | | | | | |
| 1 | 21.8907 | 21.8885 | 0.0022 | 25.1 | 0.09 | 0.07 | <.2 | No Effect | Passes |
| 2 | 20.4263 | 20.4252 | 0.0011 | 25.1 | 0.04 | | | No Effect | Passes |
| Aluminum | | | | | | | | | |
| 1 | 3.8200 | 3.8196 | 0.0004 | 24.7 | 0.02 | 0.01 | <.1 | No Effect | Passes |
| 2 | 3.5742 | 3.5739 | 0.0003 | 24.7 | 0.01 | | | No Effect | Passes |
| Cast Iron | | | | | | | | | |
| 1 | 26.6130 | 26.6043 | 0.0067 | 26.3 | 0.33 | 0.33 | <.1 | Pitted | Failed |
| 2 | 22.6063 | 22.7977 | 0.0066 | 26.3 | 0.33 | | | Pitted | Failed |
| Brass | | | | | | | | | |
| 1 | 22.391 | 22.387 | 0.0040 | 24.8 | 0.16 | 0.15 | <.4 | No Effect | Passes |
| 2 | 21.7238 | 21.7204 | 0.0034 | 24.8 | 0.14 | | | No Effect | Passes |
| Copper | | | | | | | | | |
| 1 | 23.6695 | 23.6666 | 0.0029 | 24.9 | 0.12 | 0.11 | <.4 | No Effect | Passes |
| 2 | 25.3417 | 25.3369 | 0.0026 | 24.9 | 0.11 | | | No Effect | Passes |

Copper Level After Test: 10 ppm by ICP Method
pH After Test: 5.38
Final Water Content: 5.23%
Source: ABIC Testing Laboratories, Inc.

These results demonstrate that the copper level (ppm) does not increase significantly when the corrosion test solution is adjusted from its initial pH of 9.54 to 5.5. The standard corrosion test conducted at a water level of 3% still passed the corrosion test with a standard approved brake fluid. Also, adjusting the initial pH of the standard corrosion test with 3% water to 5.5 increased the weight loss on the metals tested. It also caused the Tinned Iron and Cast Iron metals tested to fail the standard corrosion test procedure according to FMVSS-116.

### EXAMPLE 2

### Materials and Methods.

ABIC Testing Laboratories, Inc., Fairfield, N.J. was authorized to perform the following test. The test procedures include the method outlined in the Federal Motor Vehicle Safety Standard (FMVSS) 116, paragraph S5.1.6, and the methods using a T-100 Paper Dry Strip and a a Hydron 5-9 Paper Dry Strip.

TABLE 3
pH Determinations on Brake Fluids

| | | | pH Test Method | | |
|---|---|---|---|---|---|
| | | | T-100 | Hydron 5-9 | FMVSS- |
| Brake | | | Paper | Paper | 116 |
| Fluid ID | Classification | pH | Dry Strip | Dry Strip | Method |
| Radiator | DOT 3 | 9.4 | 9.4 | 9.4* | 9.4 |
| Specialties- | | 6.5 | 6.5** | 6-6.5*** | 6.5 |
| Gunk | | 5.5 | 5.5**** | 5.5***** | 5.5 |

*Appears slightly darker than shown paper in chart
**Slightly more green in color than orange but good match
***Good match, slightly less in color than standard chart
****Good match in color compared to chart

1. A method for assessing whether brake fluid in a vehicle should be replaced comprising:
(a) obtaining a sample of brake fluid from a vehicle;
(b) measuring the pH of the brake fluid; and
(c) assessing whether the brake fluid in the vehicle should be replaced.

2. The method according to claim 1 further comprising comparing the pH of the brake fluid to a reference value or standard.

3. The method according to claim 1 wherein the assessing whether brake fluid in a vehicle should be replaced includes determining whether the pH of the brake fluid is less than about 6.0.

4. The method according to claim 1 wherein the assessing whether brake fluid in a vehicle should be replaced includes determining whether the pH of the brake fluid is less than about 5.5.

5. The method according to claim 1 further comprising measuring the concentration of one or more metal selected from the group consisting of copper, iron, and zinc.

6. The method according to claim 1 wherein the measuring the pH of the brake fluid is performed using a reactive test strip adapted to measure the pH of brake fluid in terms of a visible color change.

7. The method according to claim 1 wherein the measuring the pH of the brake fluid is performed in an automated manner using an optical instrument.

8. A method for evaluating the degradation of brake fluid comprising:
(a) obtaining a sample of brake fluid from a vehicle;
(b) measuring the pH of the brake fluid; and
(c) evaluating the degradation of brake fluid.

9. The method according to claim 8 further comprising comparing the pH of the brake fluid to a reference value or standard.

10. The method according to claim 8 wherein the evaluating the degradation of brake fluid includes determining whether the pH of the brake fluid is less than about 6.0.

11. The method according to claim 8 wherein the evaluating the degradation of brake fluid includes determining whether the pH of the brake fluid is less than about 5.5.

12. The method according to claim 8 further comprising measuring the concentration of one or more metal selected from the group consisting of copper, iron, and zinc.

13. The method according to claim 8 wherein the measuring the pH of the brake fluid is performed using a reactive test strip adapted to measure the pH of brake fluid in terms of a visible color change.

14. The method according to claim 8 wherein the measuring the pH of the brake fluid is performed in an automated manner using an optical instrument.

15. A method for assessing the virtual age of brake fluid comprising:
(a) obtaining a sample of brake fluid from a vehicle;
(b) measuring the pH of the brake fluid; and
(c) assessing the virtual age of brake fluid.

16. The method according to claim 15 further comprising comparing the pH of the brake fluid to a reference value or standard.

17. The method according to claim 15 wherein the assessing the virtual age of brake fluid includes determining whether the pH of the brake fluid is less than about 6.0.

18. The method according to claim 15 wherein the assessing the virtual age of brake fluid includes determining whether the pH of the brake fluid is less than about 5.5.

19. The method according to claim 15 further comprising measuring the concentration of one or more metal selected from the group consisting of copper, iron, and zinc.

20. The method according to claim 15 wherein the measuring the pH of the brake fluid is performed using a reactive test strip adapted to measure the pH of brake fluid in terms of a visible color change.

21. The method according to claim 15 wherein the measuring the pH of the brake fluid is performed in an automated manner using an optical instrument.

22. A kit useful for assessing whether brake fluid in a vehicle should be replaced or useful for evaluating the degradation of brake fluid or useful for assessing the virtual age of brake fluid comprising a means for measuring the pH of the brake fluid.

23. The kit according to claim 22 wherein the means for measuring the pH of the brake fluid is a test strip or an automated instrument or device for measuring the pH.

24. The kit according to claim 22 further comprising a color chart for correlating the color of a test strip to an actual pH or an automated device for correlating the color of a test strip to an actual pH.

25. The kit according to claim 22 further comprising a means for obtaining a sample of brake fluid from a vehicle.

26. The kit according to claim 22 further comprising instructions useful for assessing whether brake fluid in a vehicle should be replaced or useful for evaluating the degradation of brake fluid or useful for assessing the virtual age of brake fluid.

27. The kit according to claim 22 wherein the instructions determine that the brake fluid in a vehicle should be replaced, or evaluate the degradation of the brake fluid as such that it is no longer safe, or assess the virtual age of the brake fluid as such that it is no longer safe to use if the pH of the brake fluid is less than about 6.0.

28. The kit according to claim 22 wherein the instructions determine that the brake fluid in a vehicle should be replaced, or evaluate the degradation of the brake fluid as such that it is no longer safe, or assess the virtual age of the brake fluid as such that it is no longer safe to use if the pH of the brake fluid is less than about 5.5.
